(19) United States
(12) Patent Application Publication
(10) Pub. No.: US 2026/0196689 A1
(43) Pub. Date: Jul. 9, 2026

(54) THREE ELECTRODE SYSTEM FOR ALL SOLID-STATE BATTERY

(71) Applicant: FORD GLOBAL TECHNOLOGIES, LLC, Dearborn, MI (US)

(72) Inventors: Wenhui Zhu, Northville, MI (US); Minghong Liu, Canton, MI (US); Chansun Park, Southfield, MI (US); Kent Snyder, Dearborn, MI (US)

(73) Assignee: FORD GLOBAL TECHNOLOGIES, LLC, Dearborn, MI (US)

(21) Appl. No.: 19/012,005

(22) Filed: Jan. 7, 2025

(51) Int. Cl. H01M 50/569; H01M 10/058; H01M 50/449

(52) U.S. Cl. CPC H01M 50/569; H01M 10/058; H01M 50/449; H01M 2300/0094

(57) ABSTRACT

A solid-state battery system includes a solid-state battery unit that comprises an anode, a cathode, and a solid electrolyte separator positioned between them to facilitate ion conduction. The system also features a reference electrode that is electrically isolated from both the anode and the cathode. This reference electrode is designed in a way that does not interfere with the ionic flow between the anode and the cathode, allowing for real-time monitoring of the anode potential during the battery's operation.

### TECHNICAL FIELD

In at least one aspect, the present invention is related to electrode systems for solid state materials.

### BACKGROUND

Solid-state batteries (SSBs) are seen as possible next-generation EV batteries with higher energy density. Lithium-based all-solid-state batteries (ASSBs) use a solid electrolyte to move ions and enable higher energy density.

### SUMMARY

In at least one aspect, a 3-electrode system for a solid-state battery that could prevent lithium plating is provided. High interfacial resistance in SSBs often leads to lithium plating, a phenomenon that reduces the battery's cycle life. Lithium plating occurs when the anode potential drops below the lithium plating potential. By introducing a reference electrode into the battery, this system allows for the measurement of the anode potential independent of the cell voltage, thereby providing a direct signal which can be used to prevent lithium plating.

In another aspect, an all solid-state battery system is provided. The all solid-state battery system includes at least a solid-state battery unit that includes an anode, a cathode, and a solid electrolyte separator positioned between them to facilitate ion conduction. The system also features a non-obstructing reference electrode that is electrically isolated from both the anode and the cathode. This non-obstructing reference electrode is designed in a way that does not interfere with the ionic flow between the anode and the cathode, allowing for real-time monitoring of the anode potential during the battery's operation.

In another aspect, the reference electrode is configured to measure an anode potential and is integrated into the solid electrolyte separator.

In another aspect, a solid-state battery system is provided. The solid-state battery system includes a solid-state battery unit including an anode, a cathode, and a solid electrolyte separator positioned between them, which facilitates ion conduction. The system also incorporates a reference electrode that is electrically isolated from both the anode and the cathode. This reference electrode can be positioned either within the solid electrolyte separator or at its perimeter and is configured to allow for the determination of the anode potential independently of the cell voltage, thereby enabling real-time monitoring of the anode potential during battery operation.

In another aspect, the anode potential is measured between the anode tab and reference electrode tab and the cathode potential is measured between cathode tab and reference electrode tab.

In another aspect, the cathode potential is measured between the cathode tab and reference electrode tab and the anode potential is calculated by subtracting cell voltage from the cathode potential.

In another aspect, a solid-state battery system is provided. The solid-state battery system includes a solid-state battery unit including an anode, a cathode, and a solid electrolyte separator positioned between the anode and the cathode to conduct ions. The system also features a reference electrode that is electrically isolated from both the anode and the cathode. The reference electrode is positioned at the perimeter of the cathode and is configured to allow for the determination of the anode potential independently of the cell voltage, enabling real-time monitoring of the anode potential during the battery's operation.

In one aspect, the three-electrode system includes reference electrode(s) positioned at the perimeter of the cathode, extending with an overhanging area of approximately the same size as the overhanging area of the anode.

In one aspect, the three-electrode system includes reference electrode(s) embedded within a solid electrolyte separator, positioned directly between the cathode and anode, with a surface area that can be substantially equal to that of the cathode.

In one aspect, the three-electrode system includes reference electrode(s) embedded within the solid electrolyte separator located in the overhanging area.

In another aspect, the reference electrode includes an electrically conductive substrate and a reference electrode active material coated onto the electrically conductive substrate.

In another aspect, a method of monitoring an anode potential in a solid-state battery system that includes an anode, a cathode, and a solid electrolyte separator is provided. The method includes a step of positioning a reference electrode within the solid electrolyte, at a perimeter of the solid electrolyte separator, or at a perimeter of the cathode. The reference electrode is electrically isolated from the anode and cathode. The anode potential is measured or calculated independently of a total cell voltage using a reference electrode tab. The charging or discharging current is adjusted based on the anode potential to prevent lithium plating.

### BRIEF DESCRIPTION OF THE DRAWINGS

For a further understanding of the nature, objects, and advantages of the present disclosure, reference should be had to the following detailed description, read in conjunction with the following drawings, wherein like reference numerals denote like elements and wherein:

FIG. 1A. Schematic of an ASSB system in which a reference electrode is positioned along the perimeter of the cathode.

FIG. 1B. Cross section of the ASSB system of FIG. 1A through the reference electrode.

FIG. 2A. Schematic of an ASSB system in which a reference electrode is embedded in the solid electrolyte separator.

FIG. 2B. Cross section of the ASSB system of FIG. 2A through the reference electrode.

FIG. 3A. Schematic of an ASSB system in which a reference electrode is embedded in the solid electrolyte separator at the overhanging region.

FIG. 3B. Cross section of the ASSB system of FIG. 3A through the reference electrode.

FIG. 4. Schematic of an ASSB system having multiple solid state battery units.

### DETAILED DESCRIPTION

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent are by weight; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed and claimed subject matter can include the use of either of the other two terms.

The phrase “composed of” means “including” or “comprising.” Typically, this phrase is used to denote that an object is formed from a material.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

In the specific examples set forth herein, concentrations, temperature, and reaction conditions (e.g., pressure, pH, etc.) can be practiced with plus or minus 50 percent of the values indicated rounded to three significant figures. In a refinement, concentrations, temperature, and reaction conditions (e.g., pressure, pH, etc.) can be practiced with plus or minus 30 percent of the values indicated rounded to three significant figures of the value provided in the examples. In another refinement, concentrations, temperature, and reaction conditions (e.g., pH, etc.) can be practiced with plus or minus 10 percent of the values indicated rounded to three significant figures of the value provided in the examples.

### Abbreviations

“ASSB” means all solid-state battery.
“SSB” means solid-state battery.

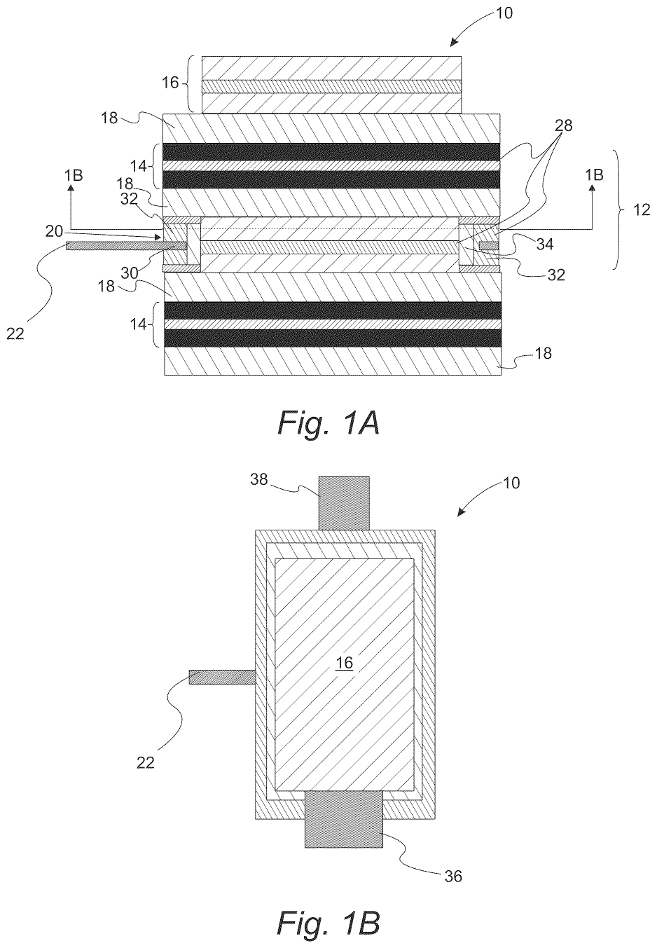

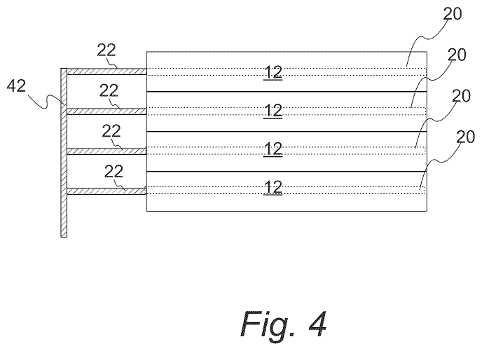

Referring to FIGS. 1A, 1B, 2A, 2B, 3A, and 3B, schematics of an all solid-state battery system are provided. SSB systems 10, 10¹, and 10² each include at least one all solid state battery unit 12. Each battery unit independently includes an anode 14 and a cathode 16. A solid electrolyte separator 18 is disposed between the anode 14 and the cathode 16. The solid electrolyte separator 18 is configured to conduct ions (e.g., lithium ions, Li⁺) between the anode 14 and the cathode 16. A reference electrode 20 is electrically isolated from the anode 14 and the cathode 16. Advantageously, the reference electrode 20 is configured (e.g., shaped and positioned) not to intervene in (i.e., interfere with) the ionic flow between the anode 14 and the cathode 16, thereby enabling real-time monitoring of the anode potential during battery operation. In this regard, the reference electrode 20 is positioned either within the solid electrolyte separator 18, at the perimeter of the cathode, or at the perimeter of the solid electrolyte separator 18. In a refinement, the reference electrode includes an electrically conductive substrate and a reference electrode material coating the electrically conductive substrate. In a further refinement, the reference electrode active material is selected from the group consisting of lithium titanate (LTO), lithium iron phosphate (LFP), lithium metal, and lithium alloys. The reference electrode 20 is configured to measure the anode potential independently of the cell voltage, enabling real-time monitoring of the anode potential during battery operation. SSB systems 10, 10¹, and 10² 10 also includes reference electrode tabs 22, which are in electrical communication and typically contact reference electrode 20. It should be appreciated that a typically SSB system can include multiple battery units 12, each of which includes an anode 14, a cathode 16 and a solid electrolyte separator 18. In one refinement, one of the battery units 12 includes reference electrode 20. Alternatively, multiple or all of the battery units includes a reference electrode 20 (see FIG. 4 described below).

In another aspect, collectively, anode 14, cathode 16, and reference electrode 20 define a three-electrode system 28. High interfacial resistance is a common challenge in solid-state batteries (SSBs) which often leads to lithium plating, a phenomenon that reduces the battery's cycle life. Lithium plating occurs when the anode potential drops below the lithium plating potential (typically near 0 V vs. Li/Li⁺) . By introducing a reference electrode into the battery, this system allows for the measurement of the anode potential independently of the total cell voltage, thereby preventing lithium plating. In a standard two-electrode battery, the voltage measured between the anode and cathode reflects the combined behavior of both electrodes. However, lithium plating can occur when the anode potential drops too low, particularly below 0 V vs. lithium. Without a reference point, it is difficult to monitor the contribution of the anode to the overall cell voltage. The reference electrode 20 provides a stable potential against which the anode's potential can be measured independently of the cathode 16. This separation enables direct measurement of the anode's absolute potential, reducing the risk of lithium plating.

In another aspect, SSB system is placed in a pouch battery cell.

The reference electrode 20 is placed within the battery, electrically isolated from the main ion flow between the anode 14 and cathode 16 by a layer of solid electrolyte. Independent measurement of the anode potential is achieved by comparing the voltage difference between the anode and the reference electrode. Similarly, the cathode potential can be measured by comparing the voltage difference between the cathode and the reference electrode (between the cathode tab and the RE tab). Alternatively, the anode potential can be calculated by subtracting the cell voltage from the measured cathode potential. In this manner, the cell voltage (anode to cathode) can be split into an anode potential (vs. reference electrode) and a cathode potential (vs. reference electrode).

By focusing on the anode potential relative to the reference electrode, the battery management system (BMS) can detect when the anode is approaching a potentially dangerous voltage (near 0 V vs. Li/Li⁺) that would induce lithium plating. The BMS can then adjust the charging or discharging current to prevent the anode potential from dropping too low, thus reduce lithium plating. This capability is crucial for preventing the formation of lithium metal on the anode surface, which can lead to dendrite growth, short circuits, and decreased battery life. In summary, the reference electrode 20 provides a stable reference point for measuring the anode potential independently of the cell voltage. This allows for real-time monitoring and adjustment to reduce lithium plating, enhancing the battery's safety and longevity. The use of a reference electrode is particularly valuable in SSBs, where high interfacial resistance and lithium plating risks are more pronounced.

FIGS. 1A and 1B illustrate an SSB system 10 in which the reference electrode 20 is positioned along the perimeter of the cathode 16. In this configuration, the reference electrode 20 consists of a substrate 30 that is coated with a reference electrode active material 32. The reference electrode active material may be lithium titanate (LTO), lithium iron phosphate (LFP), lithium metal, or a lithium alloy. The substrate 30 can be a foil, foam, or mesh composed of metals such as aluminum (Al) or copper (Cu). In a variation, SSB system 10 can be applied to SSB's based on sodium or other candidate materials. In such systems, the reference electrode active material is suitable for such variations. In a further refinement, the substrate 30 extends to form a reference electrode tab 22. As described above, the reference electrode 20 is electrically isolated from the cathode 16 by a solid electrolyte layer 34. The cathode potential can be measured between the cathode tab 36 and the reference electrode tab 22. The anode potential can be determined by subtracting the cathode potential from the overall cell voltage.

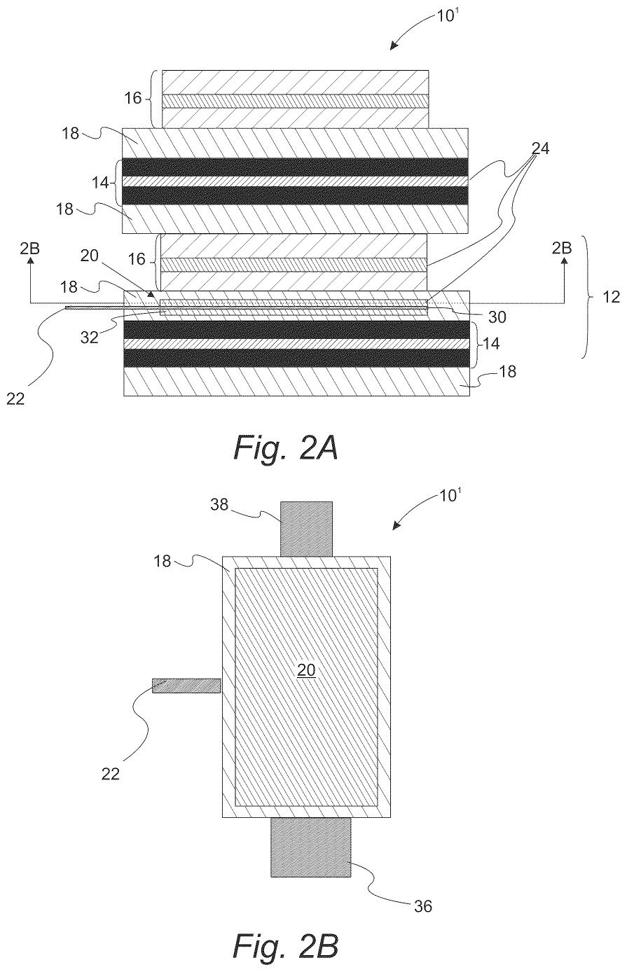

FIGS. 2A and 2B illustrate an SSB system 10¹ in which the reference electrode 20 is embedded within the solid electrolyte separator 18. In this configuration, the reference electrode 20 directly faces both the cathode 16 and the anode 14 and has substantially the same surface area as the cathode 16. In a refinement, the surface area of the reference electrode 20 is within plus or minus 10% of the area of the cathode 16. The reference electrode 20 consists of a substrate 30 coated with a reference electrode active material 32. Suitable reference electrode active materials include lithium titanate (LTO), lithium iron phosphate (LFP), lithium metal, or a lithium alloy. In one refinement, the reference electrode active material 32 is blended with a solid electrolyte material. The substrate 30 can be made from a foam or mesh composed of metals such as aluminum (Al) or copper (Cu). In further refinement, substrate 30 extends into lead/tab 22. As described earlier, the reference electrode 20 is electrically isolated from the cathode 16 and anode 14 by a solid electrolyte layer (e.g., separator 18). The anode potential can be measured between the anode 14 using anode tab 38 and the reference electrode tab 22, while the cathode potential can be measured between the cathode tab 36 and the reference electrode tab 22.

Still referring to FIGS. 2A and 2B, the reference electrode 20 is sandwiched between two solid electrolyte layers (i.e., separator 18). In a refinement, these layers are thin. This can be achieved by laminating the three layers together to form a laminated structure that can maintain a uniform thickness across a solid-state battery unit. In a refinement, any overhanging area is filled with solid electrolyte via 3D printing prior to lamination. Alternatively, the solid electrolyte can be directly coated on both sides of the reference electrode 20 before lamination. The total thickness of the solid electrolyte separator embedding the reference electrode 20 can be the same as the other solid electrolyte separators within the electrode stack.

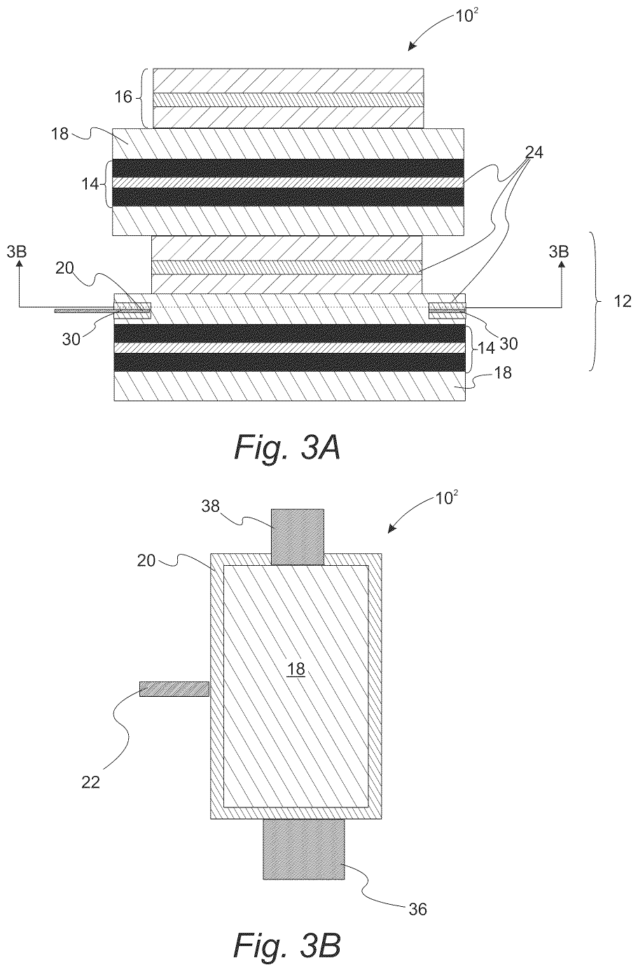

FIGS. 3A and 3B illustrate an ASSB system 10² in which the reference electrode 20 is positioned in the overhanging area of solid electrolyte separator 18. The reference electrode 20 can be composed of materials such as lithium titanate (LTO), lithium iron phosphate (LFP), lithium metal, or a lithium alloy, with the active material blended with a solid electrolyte material. The reference electrode 20 is applied onto a substrate 30, which may be a foam or mesh made of aluminum (Al) or copper (Cu). The substrate 30 extends to form a lead/tab 22. The reference electrode 20 covers the overhanging area of solid electrolyte separator 18 and is electrically isolated from the cathode 16 and anode 14 by a solid electrolyte separator 18. The anode potential can be measured between the anode 14 using anode tab 38 and the reference electrode tab 22, while the cathode potential can be measured between the cathode tab 36 and the reference electrode tab 22.

The reference electrode 20 is positioned on the edge of the solid electrolyte separators. In a refinement, the reference electrode has a surface area that is substantially equal to the surface area of the overhanging area of the anode. In one variation, this can be achieved by 3D printing the reference electrode 20 onto the edge of a thin solid electrolyte separator 18 and then filling the center and top portions with solid electrolyte before lamination. Alternatively, the reference electrode 20 can be made to match the size of the anode 14 by coating the reference electrode slurry onto the substrate 30, and then cutting out the center portion to match the dimensions of the cathode 16. The reference electrode 20, once formed, is laminated with the solid electrolyte separator 18 to create the final structure. The total thickness of the reference electrode-embedded solid electrolyte separator is designed to be consistent with the other solid electrolyte separators within the electrode stack.

In another aspect, a single reference electrode 20 can be positioned within a layer of the separator 18 or the cathode 16, as depicted in FIGS. 1 to 3. Alternatively, multiple reference electrodes 20 can be positioned in different layers. In a refinement, multiple reference electrodes 20 are embedded across several layers of separators 18 or cathodes 16. Referring to FIG. 4, SSB systems 10, 10¹, and 10² can include a plurality of solid-state battery units 12. Multiple or all of the battery units 12 include reference electrode 20. The reference electrode tabs 22 of these reference electrodes 20 can be welded together to form a single reference electrode terminal 42, which may be located on a different side of the cell from the cathode tab 36 and anode tab 38 or on the same side as the cathode tab 36 or anode tab 38. In another variation, each reference electrode 20 may have its own terminal, allowing for the independent measurement of the potential in individual layers of the cathode 16 or anode 14.

In another aspect, a method of monitoring an anode potential in the solid-state battery systems of FIGS. 1-3 is provided. The method includes a step of positioning a reference electrode 20 within the solid electrolyte separator 18, at a perimeter of the solid electrolyte separator 18, or at a perimeter of the cathode 16. The reference electrode is electrically isolated from the anode 14 and cathode 16. The anode potential is measured or calculated independently of a total cell voltage using a reference electrode tab. The charging or discharging current is adjusted based on the anode potential to prevent lithium plating.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A solid-state battery system including a solid state battery unit comprising:
an anode;
a cathode;
a solid electrolyte separator disposed between the anode and the cathode, configured to conduct ions between the anode and the cathode; and
a non-obstructing reference electrode electrically isolated from the anode and the cathode, wherein the non-obstructing reference electrode is configured not to interfere with ionic flow between the anode and the cathode.

2. The solid-state battery system of claim 1, wherein the non-obstructing reference electrode is configured to measure an anode potential and is integrated into the solid electrolyte separator.

3. The solid-state battery system of claim 1, wherein the non-obstructing reference electrode is positioned on a perimeter of the cathode.

4. The solid-state battery system of claim 1, wherein the non-obstructing reference electrode is embedded within the solid electrolyte separator.

5. The solid-state battery system of claim 4, wherein the non-obstructing reference electrode directly faces the cathode and the anode with a surface area substantially equal to that of the cathode.

6. The solid-state battery system of claim 5, wherein the non-obstructing reference electrode is sandwiched between two solid electrolyte layers, forming a laminated structure that maintains a uniform thickness across a solid state battery unit.

7. The solid-state battery system of claim 1, wherein the non-obstructing reference electrode is positioned at an overhanging area of the solid electrolyte separator.

8. The solid-state battery system of claim 7, wherein the non-obstructing reference electrode has a surface area that matches the overhanging area of the cathode.

9. The solid-state battery system of claim 1, wherein the non-obstructing reference electrode comprises:
an electrically conductive substrate; and
a reference electrode active material coated onto the electrically conductive substrate.

10. The solid-state battery system of claim 9, wherein the reference electrode active material is selected from the group consisting of lithium titanate (LTO), lithium iron phosphate (LFP), lithium metal, and lithium alloys.

11. The solid-state battery system of claim 9, wherein the reference electrode active material is blended with solid electrolyte material.

12. The solid-state battery system of claim 1, further comprising a cathode tab in electrical communication with the cathode and an anode tab in electrical communication with the anode, wherein a cathode potential is measured between the cathode tab and a reference electrode tab, and an anode potential is measured between the anode tab and the reference electrode tab.

13. The solid-state battery system of claim 1, wherein multiple reference electrodes are positioned in different layers of the solid electrolyte separator or cathode.

14. The solid-state battery system of claim 13, wherein each reference electrode has its own terminal, enabling independent measurement of a potential of individual layers of the anode or the cathode.

15. A solid-state battery system including a solid state battery unit comprising:
an anode;
a cathode;
a solid electrolyte separator disposed between the anode and the cathode, configured to conduct ions between the anode and the cathode; and
a reference electrode electrically isolated from the anode and the cathode, positioned at a perimeter of the cathode.

16. The solid-state battery system of claim 15, wherein an anode potential is measured between the anode and reference electrode tab and a cathode potential is measured between cathode tab and reference electrode tab.

17. The solid-state battery system of claim 15, wherein a cathode potential is measured between cathode tab and reference electrode tab and an anode potential is calculated by subtracting cell voltage from a cathode potential.

18. A solid-state battery system including a solid state battery unit comprising:
an anode;
a cathode;
a solid electrolyte separator disposed between the anode and the cathode, configured to conduct ions between the anode and the cathode; and
a reference electrode electrically isolated from the anode and the cathode, wherein the reference electrode is positioned either within the solid electrolyte separator or at a perimeter of the solid electrolyte separator.
